(19) United States
(12) Patent Application Publication
(10) Pub. No.: US 2005/0102564 A1
(43) Pub. Date: May 12, 2005

(54) Terminal, system and method of managing log data

(76) Inventors: Shigeto Oeda, Fujisawa (JP); Takayuki Yamamoto, Yokohama (JP)

Correspondence Address: MCDERMOTT, WILL & EMERY, 600 13th Street, N.W., Washington, DC, 20005-3096, US

(21) Appl. No.: 10/806,339

(22) Filed: Mar. 23, 2004

(30) Foreign Application Priority Data
Nov. 11, 2003 (JP) 2003-380628

(51) Int. Cl. G06F 11/00

(52) U.S. Cl. 714/20

(57) ABSTRACT

In order to effectively utilize user log data notified in a plurality of formats, collective management of the user log data is realized by judging the format of user log data, and if the judged format of the user log data is different from a predetermined format, the judged format of the user log data is converted into the predetermined format.

### BACKGROUND OF THE INVENTION

1. Field of the Invention

The present invention relates to a log data management system for collecting log data of user terminals.

2. Description of the Related Art

An invention relevant to the present invention is described in Publication JP-A-10-293704. This disclosed invention has as its object “managing log data normalized in a common data format” and has as its advantageous effects “after an agent monitors a plurality of log files and receives log data output in a variety of formats, the log files are normalized to convert them into the common data format.”, by utilizing “a log data generator and a log data storage module for cutting off values corresponding to predefined data items from log data in a log file under monitoring, and disposing values of prescribed data items to obtain normalized log data and store it”.

### SUMMARY OF THE INVENTION

Although Publication JP-A-10-293704 describes “a log data generator and a log data storage module for cutting off values corresponding to predefined data items from log data in a log file under monitoring, and disposing values of prescribed data items to obtain normalized log data and store it”, it does not describe that user log data is converted into a predetermined format and then a plurality of access log data are converted into a single format. According to the present invention, the format of log data is checked and if this check indicates that the format of log data is different from a predetermined format, the format of log data is converted into the predetermined format. Collective management of a plurality of log data can be conducted by managing the log data converted in the predetermined format.

### BRIEF DESCRIPTION OF THE DRAWINGS

These and other objects, features and advantages of the present invention will become more readily apparent from the following detailed description when taken in conjunction with the accompanying drawing wherein:

FIG. 1 is a block diagram showing the configuration of a browsing device.

FIG. 2 is a block diagram showing the configuration of a log data managing device.

FIG. 3 is a diagram showing the configuration of a contents providing and utilizing system.

FIG. 4 is a diagram illustrating an operation of a log data normalizer.

FIG. 5 is a diagram showing the configuration of another contents providing and utilizing system.

FIG. 6 is a diagram showing the configuration of another browsing device.

FIG. 7 is a diagram illustrating an operation of the log data normalizer.

FIG. 8 is a diagram showing the configuration of another contents providing and utilizing system.

FIG. 9 is a diagram illustrating an operation of another browsing device.

FIG. 10 is a block diagram showing the configuration of another log data managing device.

FIG. 11 is a diagram showing the configuration of another browsing device.

FIG. 12 is a diagram showing the configuration of another contents providing and utilizing system.

FIG. 13 is a diagram showing the configuration of another browsing device.

FIG. 14 is a block diagram showing the configuration of another log data managing device.

### DETAILED DESCRIPTION OF THE EMBODIMENTS

### 1. First Embodiment

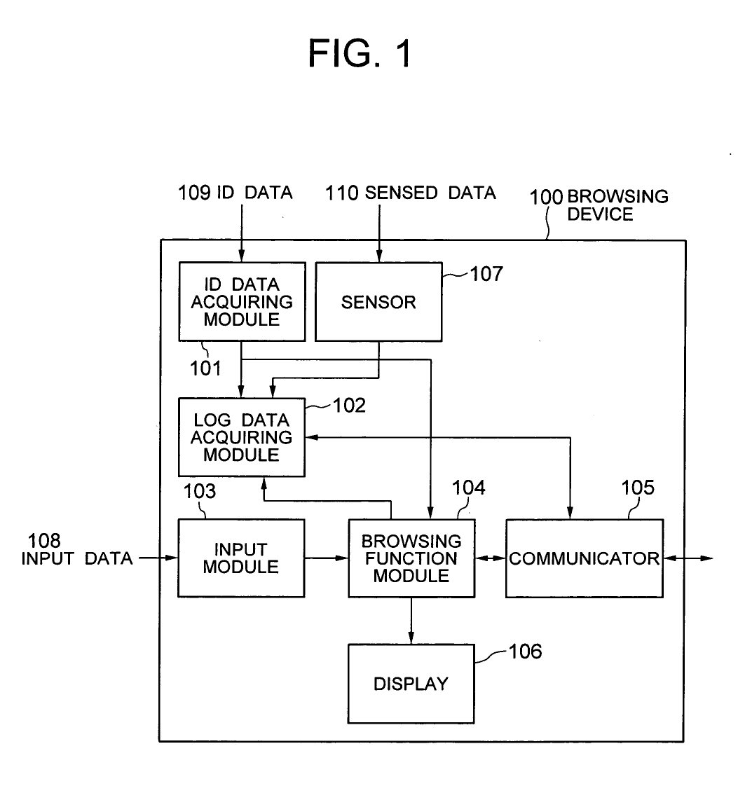

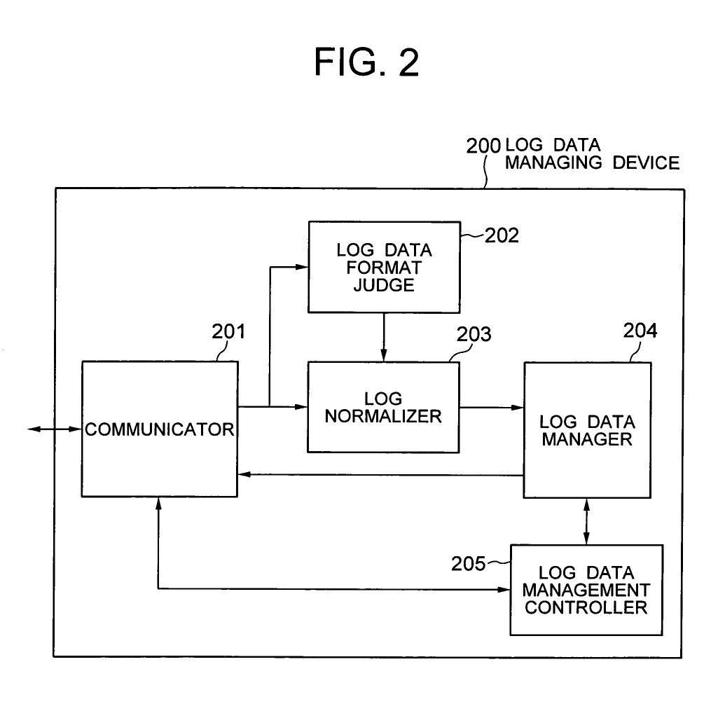

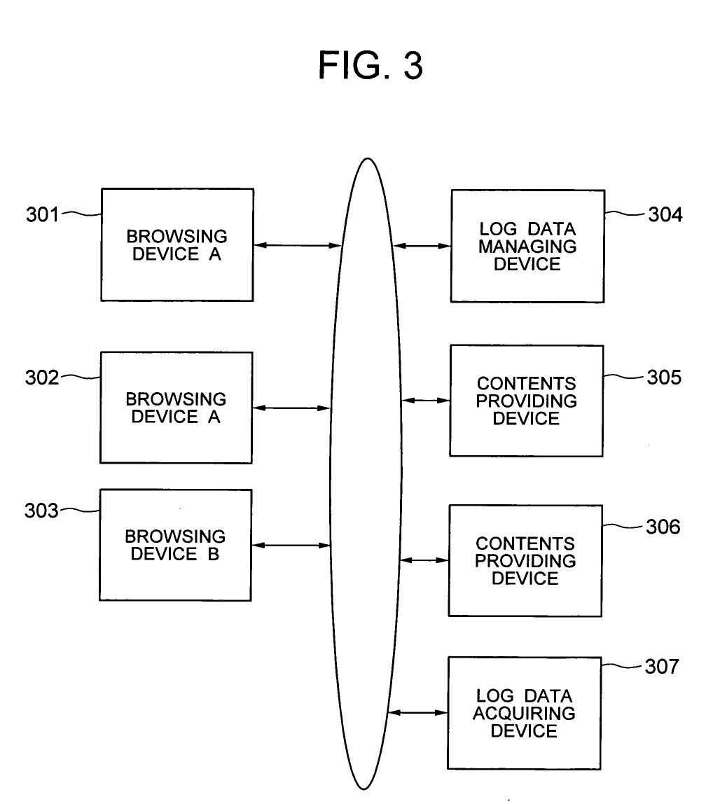

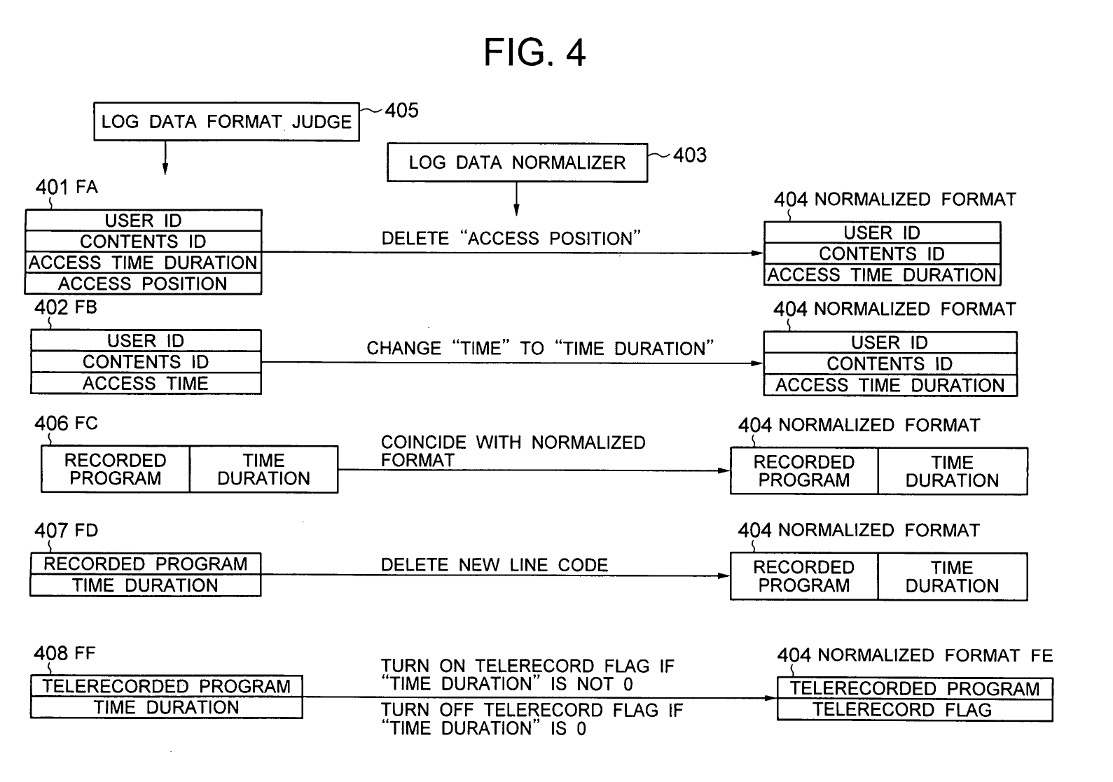

The first embodiment of the present invention will be described with reference to FIGS. 1 to 4. FIG. 1 is a block diagram showing the configuration of a browsing device, FIG. 2 is a block diagram showing the configuration of a log data managing device, FIG. 3 is a diagram showing the configuration of a contents providing and utilizing system, and FIG. 4 is a diagram illustrating an operation of a log data normalizer.

The operation of the contents providing and utilizing system of the first embodiment will be described with reference to FIG. 3. Referring to FIG. 3, browsing devices 301 and 302 can provide user log data in a format FA, and a browsing device 303 can provide user log data in a format FB. Contents providing devices 305 and 306 provide the browsing devices with contents. A log data managing device 304 acquires and manages user log data provided by the browsing devices. A log data acquiring device 307 utilizes normalized log data managed by the log data managing device 304. Users at the browsing devices 301 to 303 perform an operation of selecting desired contents and other operations to acquire contents possessed by the contents providing devices 305 and 306. The browsing devices 301 to 303 generate user log data in response to the user contents select operation, and notifies the user log data to the log data managing device 304. The log data managing device 304 checks the format of received user log data, normalizes the user log data having a different format, and stores the normalized log data when necessary. The log data acquiring device 307 can acquire normalized log data satisfying particular conditions, when necessary.

FIG. 1 is a block diagram showing the configuration of a browsing device 100 or user terminal. The browsing device 100 is constituted of: an ID acquiring module 101 for acquiring ID data of a user in a contact or non-contact manner; a log data acquiring module 102 for generating user log data from user data notified from the ID acquiring module 101, a browser function module 104 and a sensor 107; an input module 103 such as a touch panel, a keyboard and a microphone; the browser function module 104 for selecting and rendering contents provided by a contents providing device (not shown); a communicator 105 for transferring contents, user log data and the like; a display 106 such as a liquid crystal display for displaying rendered contents; and the sensor 107 for sensing user data.

In this embodiment, it is assumed that the contents to be provided are text data written in Hyper Text Markup Language (HTML) which is standard in World Wide Web (WWW), and that the browser function module 104 has the function of analyzing and rendering HTML. It is also assumed that the communicator 105 has a physical network function equivalent to Ethernet and its upper level communication function such as a TCP/IP function.

With reference to FIG. 1, the operation of the browsing device as a user terminal will be described. By using the browsing device of this embodiment, a user can access HTML contents provided by contents providing devices (Web servers). The ID acquiring module 101 acquires user ID data, for example, by using a wireless tug device possessed by the user. The sensor 107 notifies the log acquiring module 102 of sensed data such as information on whether or not the user gazes steadily the display 106, obtained by using a camera and an image analyzing function. Another sensor (not shown) 107 capable of sensing position information notifies the log data acquiring module 102 of the position information of the browsing device. The browser function module 104 notifies the log data acquiring device 102 of a contents ID (URL information) for identifying the contents designated by the user and an access time duration while contents having one contents ID is selected. The log data acquiring module 102 acquires: the ID data acquired by the ID acquiring module 101; the contents ID and access time duration notified by the browsing function module 104; and gazing and position information notified by the sensor 107. In accordance with these information, the log data acquiring module 102 executes the following process every predetermined time: (a) if the gazing information is true (if a user gazes steadily the display), the access time duration notified by the browsing function module 104 is used as the access time duration of the user log data, (b) in the other case (if a user does not gaze steadily the display), the access time duration of the user log data is set to 0. The total sum of access time durations of (a) or (b) is calculated for each contents ID, and this total sum of access time durations is used as the access time duration of each of the contents.

FIG. 2 shows the configuration of the log data managing device 200. A communicator 201 is similar to the communicator 105. A log data format judge 202 judges the format of user log data. A log normalizer 203 normalizes user log data in accordance with the log data format judged by the log data format judge 202. A log data manager 204 records and manages the normalized user log data. A log data management controller 205 controls read/write of the user log data managed by the log data manager 204.

The operation of the log data managing device will be described with reference to FIG. 4. User log data 401 is constituted of the user ID, contents ID, access time duration and position information (access position) generated by the processes of the log data acquiring module 102, and notified to the log data managing device at regular intervals. User log data 402 is notified by the log data acquiring module of another browsing device (not shown). Although this user log data 402 has the user ID and contents ID similar to the user log data 401, it has an access time when an access to the contents having a particular contents ID starts, instead of the access time duration. The log data format judge 202 judges the format each time user log data is notified. In this embodiment, the format of the user log data 401 is represented by FA and the format of the user log data 402 is represented by FB. In accordance with constituent elements of the user log data such as the user ID and contents ID, the log data format judge judges the format of user log data. In this embodiment, the log data format judge 202 executes the following process: (a) if the user log data contains the item of the access time duration, the log data formation judge judges as the format FA, and (b) in the other case, it judges as the format FB.

Next, with reference to FIG. 4, the operation of the log data normalizer will be described.

If the format notified by the log data formation judge 405 is FA, the log data normalizer 403 judges that the user log data 401 is constituted of the user ID, contents ID, access time duration and access position, and generates normalized log data by deleting the data of the access position.

If the format notified by the log data formation judge 405 is FB, the log data normalizer 403 judges that the user log data 402 is constituted of the user ID, contents ID and access time T1, and when an access time T2 of user log data for the different contents ID is acquired, calculates an access time duration T2−T1 and uses the result as the normalized log data.

If the format notified by the log data format judge 405 is FC, the log data normalizer 403 judges that this format is the same as the normalized format, and uses this format itself as the normalized format.

If the format notified by the log data format judge 405 is FD, the log data normalizer 403 deletes a new line code to generate the normalized format.

If the normalized format consists of plural lines, the log data normalizer 403 inserts new line codes between data.

If the format notified by the log data format judge 405 is FF, the log data normalizer 403 changes an time duration to a telerecord flag to generate the normalized format FE. The telerecord flag is turned ON if the time duration is not 0, whereas it is turned OFF if the time duration is 0.

As above, user log data in a variety of formats can be processed by using the log data format judge 405 and log data normalizer 403 of the present invention.

According to the embodiment, user log data can be utilized in the contents providing and utilizing system having a mixture of a plurality type of browsing devices (terminals) each notifying user log data by using different user log data formats. User log data can be acquired from a number of different devices. The scale and precision of acquired normalized user log data are expected to be improved. Since the log data normalizer is provided not on the terminal side but on the managing device side, the efficiency and cost can be improved. The format of normalized log data can be changed by the managing device alone, avoiding cumbersome works at terminals. Even if the same terminal group is used, user log data can be collected by using a plurality of different normalized log data formats.

According to the embodiment, each time a user uses a browsing device, the user log data regarding the user ID and access contents can be acquired collectively by the log data managing device. By using the normalized log data, the log data acquiring module can acquire the total sum of contents access time durations for each user ID, and can acquire the user ID of a user accessed particular contents. For example, by using the normalized log data, a user accessed particular contents may be notified of additional information by e-mail.

In this embodiment, although a browsing device is used as the terminal, the type of the terminal is not limited only thereto, but other terminals may also be used such as personal computers, audio visual devices and white electrical home appliances. The type of the terminal is not limited specifically.

In this embodiment, the installation locations of terminals are not limited specifically, and they may be installed in or outside the home. The installation type may be a fixed type or a portable type. The installation locations and the fixed type and portable time of terminals are not limited.

In this embodiment, although the log data format judge judges user log data of the two formats, the number of formats and the judging method are not limited specifically.

In this embodiment, although the user log data of the browsing device is notified at regular intervals, it may be notified when contents are selected, after a predetermined time lapse from contents selection, or when manipulating the browsing device is terminated. The notice timings of user log data are not limited specifically. The timings of generating normalized log data at the log data managing device for acquiring user log data and the timings of recording normalized log data are not limited specifically.

In the embodiment, although the browsing device knows in advance the log data managing device to which user log data is notified, the browsing device itself may search and determine the log data managing device, or a user, a browsing function module or another application may determine the log data managing device. A method of designating the log data managing device is not limited specifically.

In the embodiment, only one log data managing device is used, although the contents providing and utilizing system may have a plurality of log data managing devices to allow different log data managing devices to generate different normalized log data. The configuration of the log data managing device, the format of user log data to be notified to the log data managing device, and the like are not limited specifically.

In the embodiment, the log data format judge judges the log data format, basing upon the presence/absence of a particular item in the user log data. The log data format of user log data may be judged from an ID number of an ID item which holds the ID number uniquely allocated to each format. The method of judging the format is not limited specifically.

### 2. Second Embodiment

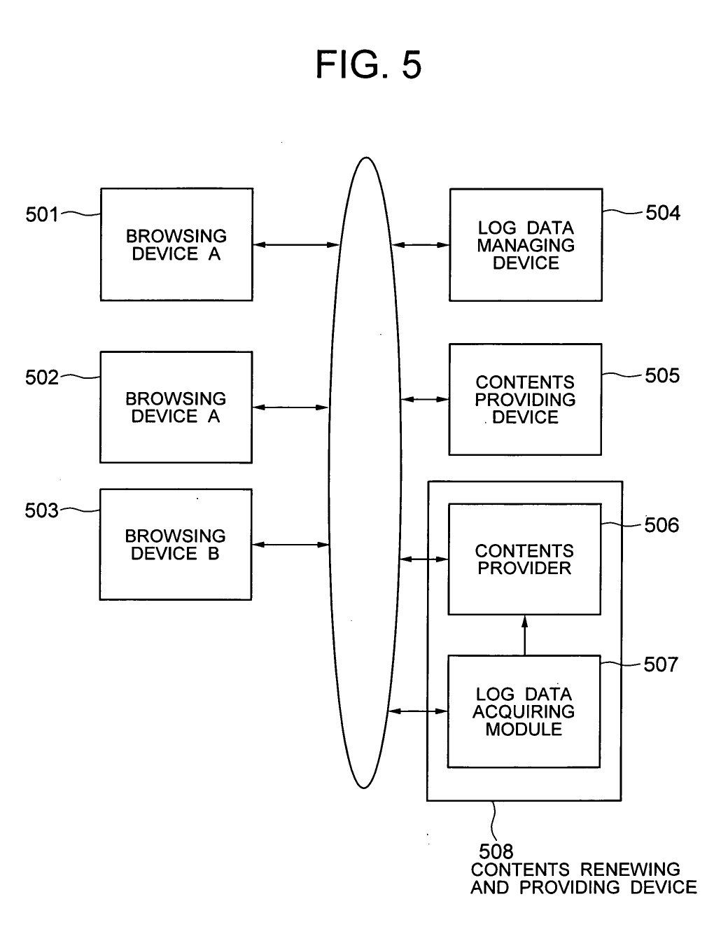

The second embodiment of the invention will be described with reference to FIG. 5. FIG. 5 is a diagram showing the configuration of a contents providing and utilizing system of the second embodiment. In the second embodiment, it is assumed that browsing devices 502 and 503, a log data managing device 504 and a contents providing device 505 have structures similar to those of the first embodiment to realize their specific operations. Referring to FIG. 5, a contents renewing and providing device 508 is constituted of a contents provider 506 and a log data acquiring module 507. The operation of the contents provider 506 and log data acquiring module 507 is similar to that of the contents providing device and log data acquiring device of the first embodiment.

The operation of the second embodiment will be described. The contents updating and providing device 508 changes the contents to be provided and a providing method in accordance with the normalized log data. For example, the normalized log data regarding the access time duration of the contents notified by the contents provider 506 is acquired from the log data acquiring module 507, and an average of access time durations of all users is calculated for each of the contents. The contents provider automatically deletes the contents whose average access time duration does not satisfy a predetermined access time duration limit.

According to the embodiment, in the contents renewing and providing device having a contents providing function that a manager registers contents when necessary, the contents having a shorter access time duration are automatically deleted to improve the efficiency of contents management. It becomes possible for a user not to designate the contents having a shorter access time duration, realizing easy-to-use.

In the embodiment, the contents to be provided are automatically managed in accordance with the normalized log data. Instead, in a contents renewing and providing device which notifies search results as contents, the search results may be presented in the order of longer average access time duration in order to provide the contents which other users often utilize. The contents to be provided, the type of normalized log data acquired from the log data acquiring module and its utilizing method are not limited specifically.

### 3. Third Embodiment

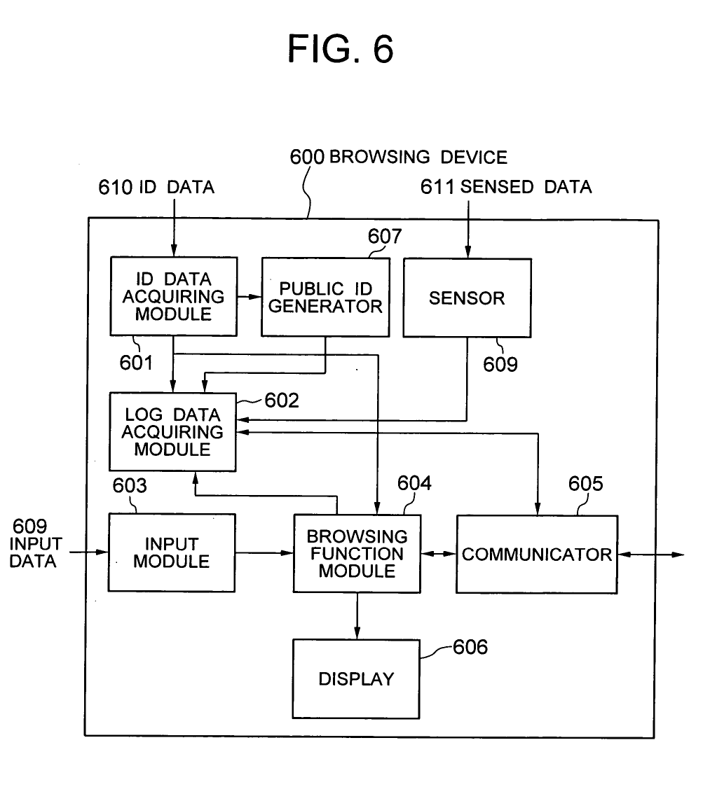

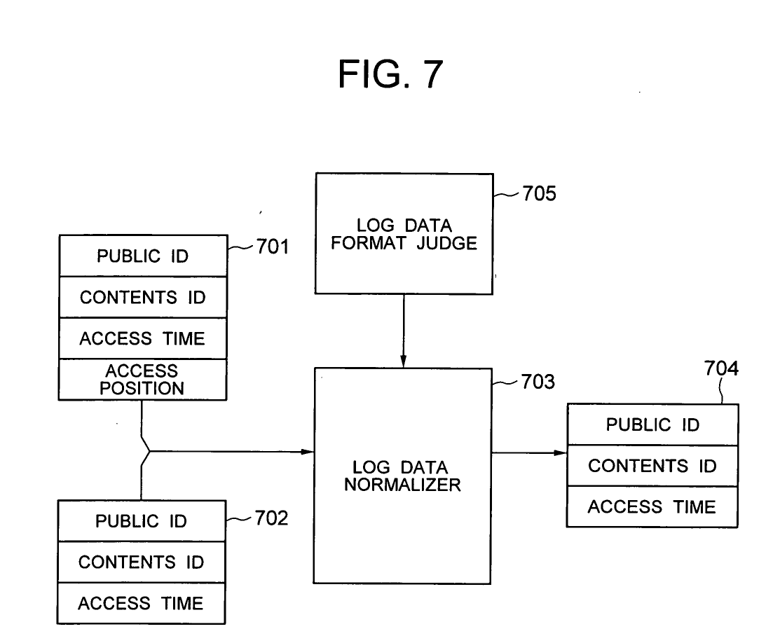

The third embodiment of the invention will be described with reference to FIGS. 6 and 7. FIG. 6 is a diagram showing the configuration of a browsing device of the third embodiment. A public ID generator 607 processes ID data of a user acquired by an ID acquiring module 601 to generate public ID data. The public ID generating method is not limited specifically. For example, the upper N bits of ID data of 2N bits are replaced with a random number to obtain public ID data. In accordance with the public ID data, a log data acquiring module 602 generates user log data. The user log data generating method and the like to be used by the log data acquiring module 602 are similar to those used by the browsing device shown in FIG. 1. According to the third embodiment, the browsing device 600 can generate and provide user log data not containing a user ID.

Next, with reference to FIG. 7, the operation of a log data normalizer 703 will be described. User log data 701 and 702 have the structure including public ID as shown in FIG. 7. The user log data 701 and 702 having different formats are notified by the browsing device 600 having the public ID generator. The log data normalizer 703 normalizes the user log data by the processes similar to those used by the log data normalizer 403 shown in FIG. 4. It is therefore possible to generate normalized log data having the public ID. The normalized log data having the public ID can be utilized by a log data acquiring device (not shown).

According to the embodiment, the user log data does not contain a user ID derived from user ID data, but can use user log data containing the public ID. It is possible to prevent piracy of user data and infringement of user privacy, realizing easy-to-use.

In this embodiment, a browsing device may be used which is of the type having a log data acquiring module capable of generating user log data by using a device ID in place of the public ID, or by using both the device ID and public ID, the device ID being generated or notified by a device ID generator. In this case, contents management becomes possible utilizing the device ID contained in the normalized log data. For example, a contents providing and utilizing system can be realized which acquires contents (contents ID) often used by the device with the device ID and provides the contents often used by the device with a priority over other contents.

### 4. Fourth Embodiment

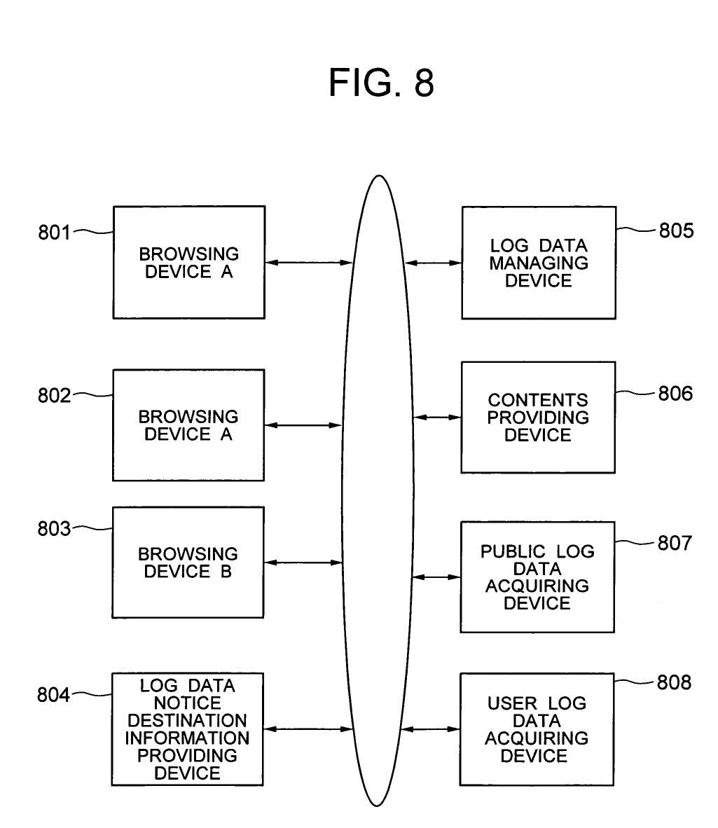

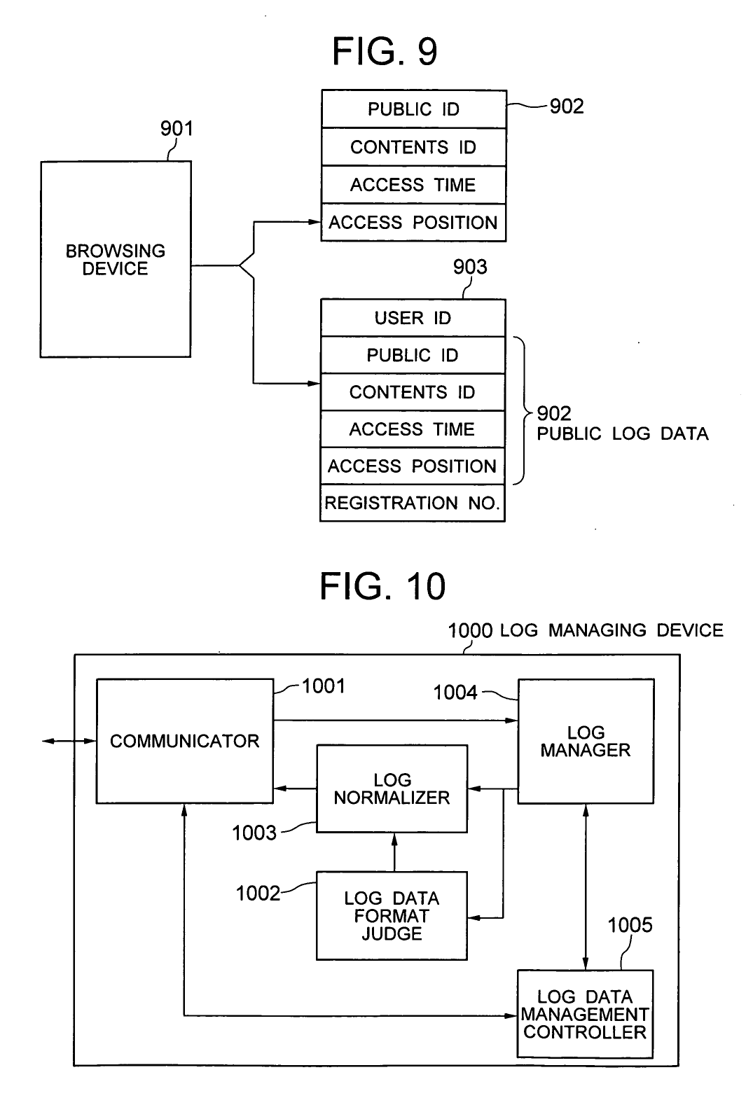

The fourth embodiment of the invention will be described with reference to FIGS. 8 and 9. FIG. 8 is a diagram showing the configuration of a contents providing and utilizing system of the fourth embodiment, and FIG. 9 is a diagram showing the configuration of user log data provided by a browsing device.

The browsing device shown in FIG. 9 has the structure similar to that of the browsing device shown in FIG. 6. A log data acquiring module (not shown) can acquire both the user log data based on the public ID and the user log data based on the user ID, in a manner similar to that of the log data acquiring module shown in FIG. 1. The browsing device notifies the generated user log data to a public log data acquiring device 807 and a user log data acquiring device 808 both designated in advance and shown in FIG. 8. At this time, the browsing device uses a log data notice destination information providing device 804. For example, user log data 903 (secret user log data or personal log data) including the user ID has user log data 902 (public user log data or public log data) including only the public ID, in addition to a registration number if the user has registered some contents. The user log data 902 is notified to the public log data acquiring device 807, whereas the user log data 903 is notified to the user log data acquiring device 808.

According to the embodiment, the user log data acquired by the browsing device can be classified into the public log data and user log data which are notified to different log data acquiring devices. For example, the public log data can be notified to a general log data acquiring device which monitors a contents access time duration, whereas the user log data can be notified to a log data acquiring device which notifies services of managing user access history. It is therefore possible to prevent piracy of user data and infringement of user privacy and to provide user log data for necessary services.

In the embodiment, although both the public log data acquiring device and user log data acquiring device are designated in advance, the log data acquiring device may be searched and designated. Alternatively, only a particular log data acquiring device may be registered as the user log data acquiring device, and all other log data acquiring devices are designated as the public log data acquiring device. A method of designating a log data acquiring device is not limited specifically.

### 5. Fifth Embodiment

The fifth embodiment of the invention will be described with reference to FIG. 10. FIG. 10 is a block diagram showing the configuration of a log data managing device. A communicator 1001 is similar to the communicator 105, a log data format judge 1002 judges the format of user log data. A log data normalizer 1003 normalizes user log data in accordance with the log data format judged by the log data format judge 1002. A log data manager 1004 records and manages user log data. A log data management controller 205 controls read/write of user log data managed by the log data manager 204.

According to the embodiment, user log data can be utilized in the contents providing and utilizing system having a mixture of a plurality type of browsing devices (terminals) each notifying user log data by using different user log data formats.

According to the embodiment, user log data before normalization can be recorded in the log data manager, and normalized in response to a log data acquisition request from the log data acquiring device. According to the embodiment, even if the normalizing process by the log data normalizer 1003 is changed during operation, all user log data managed under the log data manager can be notified in the form of normalized log data compatible with the new normalizing process, and in addition the user log data before normalization can also be notified, realizing easy-to-use.

### 6. Sixth Embodiment

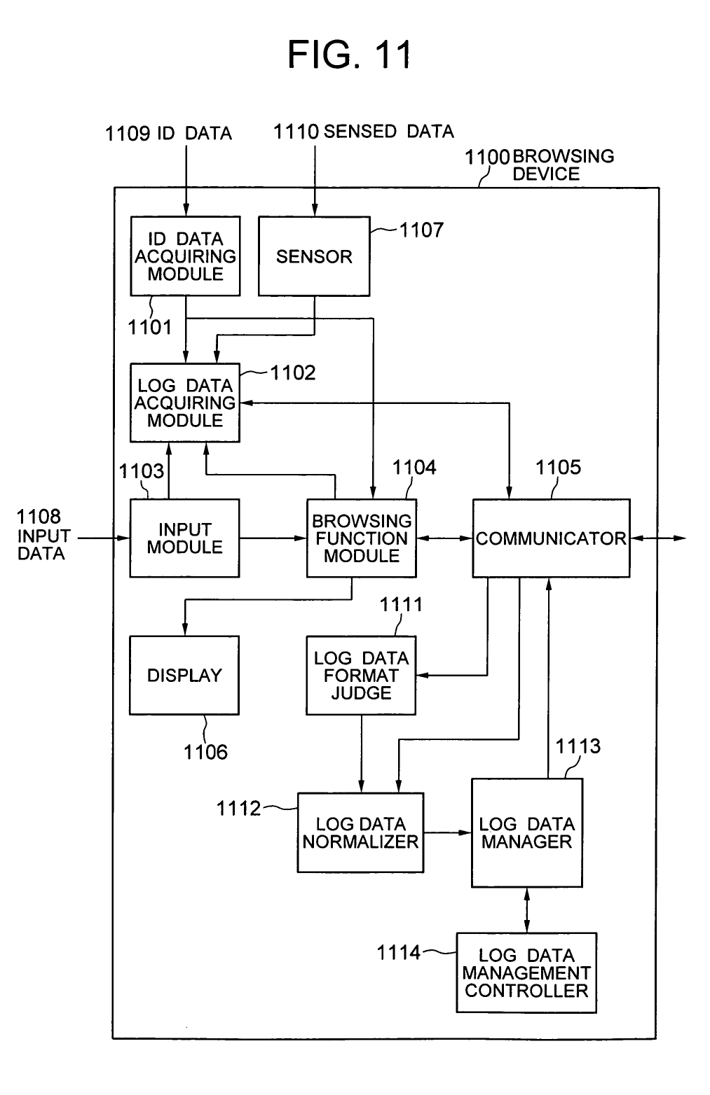

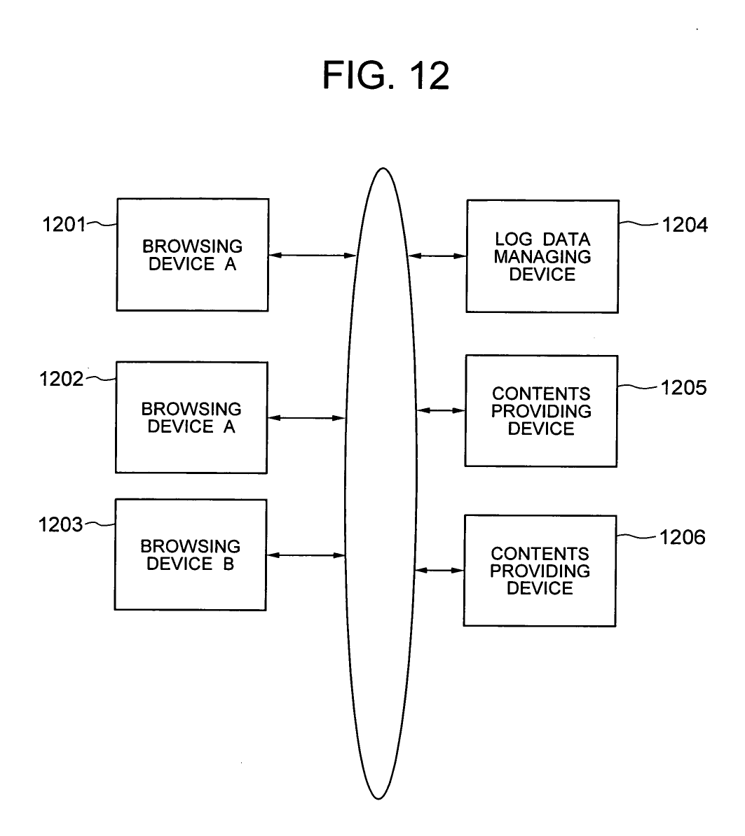

The sixth embodiment will be described with reference to FIGS. 11 and 12. FIG. 11 is a block diagram showing the configuration of a browsing device of the sixth embodiment, and FIG. 12 is a block diagram showing the configuration of a contents providing and utilizing system. Referring to FIG. 11, the browsing device 1100 is constituted of: an ID acquiring module 1101 for acquiring ID data of a user in a contact or non-contact manner; a log data acquiring module 1102 for generating user log data from user data notified from the ID acquiring module 1101, a browser function module 1104 and a sensor 1107; an input module 1103 such as a touch panel, a keyboard and a microphone; the browser function module 1104 for selecting and rendering contents provided by a contents providing device (not shown); a communicator 1105 for transferring contents, user log data and the like; a display 1106 such as a liquid crystal display for displaying rendered contents; the sensor 1107 for sensing user data; a log data format judge 1111 for judging the format of user log data; a log data normalizer 1112 for normalizing user log data in accordance with the log data format judged by the log data format judge 1111; a log data manager 1113 for recording and managing the normalized user log data; and a log data management controller 1114 for controlling read/write of the user log data managed by the log data manager 1113.

The operation of the embodiment will be described. The ID acquiring module 1101, log data acquiring module 1102, input module 1103, browsing function module 1104, communication function module 1105, display 1106 and sensor 1107 execute operations similar to the browsing device shown in FIG. 1. The log data format judge 1111, log data normalizer 1112, log data manager, 1113 and log data management controller 1114 execute operations similar to the log data managing device shown in FIG. 2. The log data manager 1113 has a function of performing log data management in cooperation with another browsing device by using the communication function module 1105, so that it is possible to perform distributed management of user log data and normalized log data.

The browsing device shown in FIG. 11 can singularly notify user log data and perform log data distributed management, dispensing with a log data managing device.

FIG. 12 shows the configuration of a contents providing and utilizing system of this embodiment. Browsing devices 1201 to 1203 notify user log data and distributively manages notified user log data. Contents providing devices 1205 and 1206 provide the browsing device with contents. A log data acquiring device 1204 can acquire normalized log data distributively managed by the browsing devices 1201 to 1203. A distributed management method for normalized log data described in this embodiment is a well known technique known as a distributed processing technique or a peer-to-peer technique.

According to the embodiment, the browsing device alone can provide or utilize user log data or normalized log data, realizing easy-to-use.

### 7. Seventh Embodiment

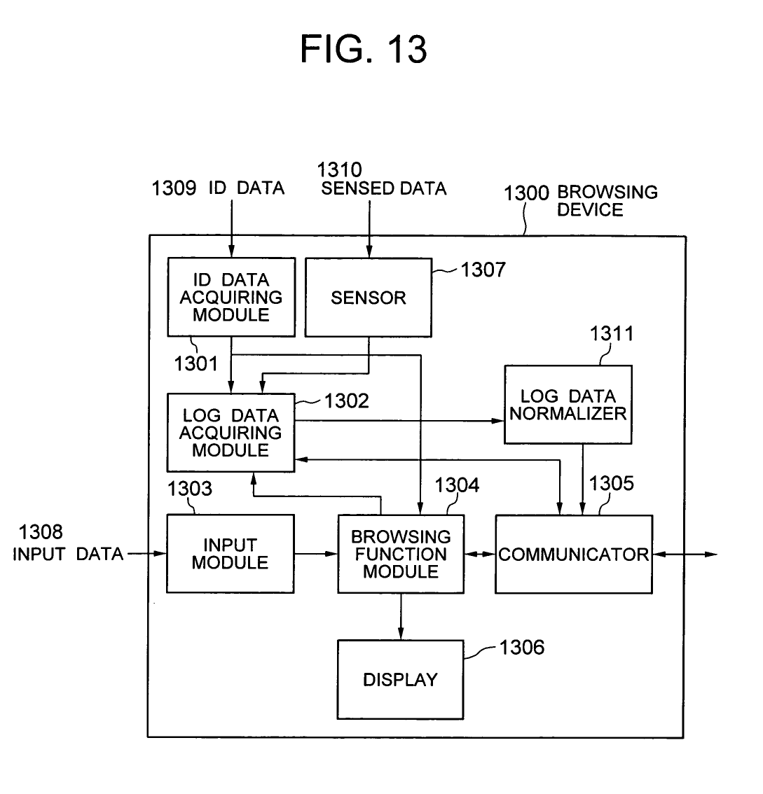

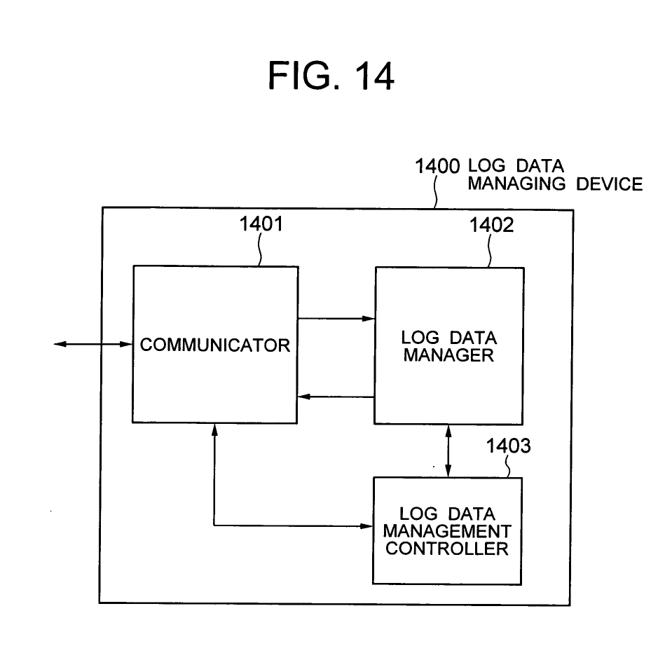

The seventh embodiment will be described with reference to FIGS. 13 and 14.

FIG. 13 is a block diagram showing the configuration of a browsing device of the seventh embodiment. In FIG. 13, all the constituent elements from an ID acquiring module 1301 to sensed data 1310 have the functions and data similar to those represented by the same name or symbol shown in FIG. 1. A log data normalizer 1311 normalizes user log data and notifies it to the communication function module. A log data acquiring module 1302 notifies user log data to a log data normalizer 1311.

The operation of the browsing device of this embodiment will be described. User log data acquired by log data acquiring module 1302 is normalized by the log data normalizer 1311 and notified to the log managing device by using a communication function module 1305.

In the above description, although the log data acquiring module 1302 notifies all user log data to the log data normalizer in order to be normalized, the log data acquiring module 1302 may selectively notify user log data either to the log data normalizer 1311 or to the communication function module 1305. This arrangement allows the browsing device to provide both the normalized log data and user log data.

FIG. 14 is a block diagram showing the configuration of a log data managing device. The log data managing device shown in FIG. 14 is constituted of: a communication function block 1401 for acquiring normalized log data or the like; a log data manager 1402 for recording and managing the acquired normalized log data; and a log data management controller 1403 for controlling management, notice and the like of the normalized log data possessed by the log data manager 1402.

The operation of the log data managing device will be described. In response to a notice of acquiring the normalized log data provided by the browsing device 1300, from the communication function module 1401, the log data management controller 1403 records the received normalized log data in the log data manager 1402. In response to a request from a log data acquiring device (not shown), the normalized log data managed by the log data manager 1402 is notified to the log data acquiring device via the communication function module 1401 under the control of the log data management controller 1403.

According to the embodiment, the browsing device can notify the normalized log data to the log data managing device, so that the log data managing device side is not necessary to judge the log data format and normalize user log data. In addition, a normalizing process can be executed distributively at respective browsing devices so that a load necessary for the normalizing process can be reduced more than normalization on the log data managing device side.

The browsing device may notify both the normalized log data and user log data. With this arrangement, the browsing device can deal with the format of normalized log data widely used and the log data managing device can deal with the format of special normalized log data, resulting in improved flexibility of the system configuration. The browsing device may notify user log data.

In all the embodiments described above, although a browsing device is used as the terminal, the type of the terminal is not limited only thereto, but other terminals may also be used such as personal computers, audio visual devices and white electrical home appliances. The type of the terminal is not limited specifically.

In all the embodiments described above, the installation locations of terminals are not limited specifically, and they may be installed in or outside the home. The installation type may be a fixed type or a portable type. The installation locations and the fixed type and portable time of terminals are not limited.

In all the embodiments, although the user log data of the browsing device is notified at regular intervals, it may be notified when contents are selected, after a predetermined time lapse from contents selection, or when manipulating the browsing device is terminated. The notice timings of user log data are not limited specifically. The timings of generating normalized log data at the log data managing device for acquiring user log data and the timings of recording normalized log data are not limited specifically.

In all the embodiments, although the browsing device knows in advance the log data managing device to which user log data is notified, the browsing device may search and determine the log data managing device, or a user, a browsing function module or another application may determine the log data managing device. A method of designating the log data managing device is not limited specifically.

In all the embodiments, the browsing device is provided specific functions such as the function of a log data acquiring module. The specific functions may be implemented by using dedicated hardware or by using programs executable by a CPU. The implementation of the specific functions are not limited specifically. The same is true for the log data managing device. The functions implemented by hardware and the functions executed by CPU may be mixed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and range of equivalency of the claims are therefore intended to be embraced therein.

1. A method of managing log data comprising the steps of:
judging a format of log data; and
if the judged format of the log data is different from a predetermined format, converting the format of the log data into the predetermined format for management of the log data.

2. A system of managing log data comprising:
a terminal having a transmitter for transmitting user log data; and
a log data managing device comprising a receiver for receiving the user log data transmitted from the transmitter, a judge for judging a format of the received user log data, a normalizer for converting the user log data to have a predetermined format if the judged format is different from the predetermined format, and a manager for collecting and managing the converted user log data.

3. A system of managing log data according to claim 2, further comprising a user data acquiring module for acquiring user data of a user, an ID acquiring module for acquiring a user ID for identifying the user, and a log data acquiring module for acquiring user log data from the user ID and the user data.

4. A system of managing log data according to claim 2, further comprising a log data acquiring device for acquiring the converted user log data, wherein the log data managing device notifies the converted log data to the log data acquiring device.

5. A system of managing log data according to claim 4, wherein in response to a request of log data acquisition from the log data acquiring device, the log data managing device notifies the converted log data to the log data acquiring device.

6. A terminal for transmitting user log data to a log data managing device, the log data managing device having a receiver for receiving the user log data, a judge for judging a format of the received user log data, a normalizer for converting the user log data to have a predetermined format if the judged format is different from the predetermined format, and a manager for collecting and managing the converted user log data, wherein the terminal comprises:
a user data acquiring module for acquiring user data of a user of the terminal;
an ID acquiring module for acquiring a user ID for identifying the user; and
a log data acquiring module for acquiring user log data from the user ID and the user data.

7. A terminal according to claim 6, further comprising a public ID generator for generating a public ID by processing the user ID acquired by the ID acquiring module.

8. A terminal according to claim 6, wherein the public ID generator generates the public ID by replacing the user ID with a random number.

9. A method of managing log data according to claim 1, wherein the conversion into the predetermined format means setting a flag if a numerical value in an item of the user log data is not 0.

10. A method of managing log data according to claim 1, wherein the conversion into the predetermined format means obtaining a time duration from a time if an item of the user log data is the time and an item of the predetermined format is the time duration.
